(19) United States
(12) Patent Application Publication
(10) Pub. No.: US 2003/0049358 A1
(43) Pub. Date: Mar. 13, 2003

(54) Chemical leavened doughs and related methods

(75) Inventor: David J. Domingues, Plymouth, MN (US)

Correspondence Address: Daniel C. Schulte, Kagan Binder, PLLC, Maple Island Building, Suite 200, 221 Main Street North, Stillwater, MN, 55082, US

(73) Assignee: The Pillsbury Company

(21) Appl. No.: 09/945,204

(22) Filed: Aug. 31, 2001

(51) Int. Cl. A21D 2/00

(52) U.S. Cl. 426/551

(57) ABSTRACT

Described are dough compositions and methods of preparing dough compositions, raw and baked, including preferred methods and compositions wherein chemical leavening agents are separated by a degradable barrier material to control their reaction until a time during baking, wherein the chemical leavening agents at least partially leaven the dough composition during baking.

### FIELD OF THE INVENTION

The invention relates to chemically leavened dough products and compositions and methods for preparing the same.

### BACKGROUND

Chemical leavening systems, as they are often included in refrigerated dough compositions, include active ingredients that chemically react to produce a gas that leavens and expands (or “proofs”) the dough. During the leavening or “proofing” process, the dough expands with the production of the gas, typically carbon dioxide.

Chemically leavened refrigerated dough products are sold packaged in spiral bound cardboard cans. Chemical leavening agents (CLAs) in the dough react to produce carbon dioxide (CO₂). This is known as a “proofing,” during which the carbon dioxide saturates the dough and causes the dough to expand. In preparing the cardboard can-type product, the dough product is placed in the cardboard can and allowed to expand and proof. Proofing causes oxygen to be displaced from the package and causes the dough to expand to entirely fill the can and seal the end lids. Normally this proofing process takes place after sealing the can, e.g., by caulking end lids, causing an internal pressure to build up in the can, often in the range of about 15 psi.

This internal pressure can be objectionable to consumers because the pressurized cardboard cans tend to pop abruptly as the internal pressure is released when the can is opened.

Presently, some encapsulated sodas are used in dough compositions to retard leavening reaction for minutes or fractions of an hour, e.g., one-half hour, to allow packaging a dough product in a can prior to an excessive volume increase.

There is a continuing need for new dough compositions and methods of packaging refrigerated dough compositions, particularly dough compositions or packaging allowing baking of the dough composition to a baked dough product that is leavened to a useful and conventional specific volume.

### SUMMARY

The invention involves the use of chemical leaveners in dough products, e.g., an acidic active ingredient and a basic active ingredient, wherein the reaction between the active ingredients can be controlled to occur at a desired time or upon a desired condition in the processing or use of the dough composition. The control can be effected based on the use of a barrier material that separates the active chemical leavening ingredients at processing conditions during which reaction and leavening are undesired, e.g., mixing, processing into a dough product configuration, packaging and storage. The barrier material can be selected to allow reaction of the active ingredients at a desired processing time or temperature, e.g., during early stages of baking during which the dough is able to expand, by breaking down to eliminate the separation between the active chemical leavening ingredients and allow contact and reaction between the two.

Properties of the active ingredients themselves and the barrier material may be independently selected and used to advantageously control the timing of reaction between the active ingredients. Reaction of active ingredients is facilitated by dissolution. Solubility of an active ingredient can be temperature dependent, so using one or more active ingredients that are relatively insoluble at processing and refrigerated storage temperatures will inhibit reaction of the active ingredients and leavening of the dough composition prior to baking, while the same active ingredient can be selected to be soluble at higher temperatures experienced upon baking, allowing for reaction. Properties of the barrier material such as melting point or solid fat index (for fat-type barrier materials) can be selected to provide enhanced control of the reaction between active ingredients.

The invention allows control and selection of the timing of reaction of the active chemical leavening ingredients, with the reaction preferably being minimized during processing, packaging, and storage, and delayed to occur substantially during baking. Such a preferred dough composition can remain substantially or completely unleavened (e.g., unproofed) during processing and storage, up until baking, and leavening can then be caused to occur substantially only during baking.

“Processing” includes steps of preparing the dough composition up to baking, e.g., mixing, compounding, or otherwise combining ingredients into a dough composition, packaging the dough composition, and storing the dough composition (particularly with refrigeration). (The terms “packaging,” and “storage” are considered to be part of “processing,” but may also be referred to separately.)

In preferred embodiments, the different components of the dough and the chemical leavening system, including the barrier material, can be selected to optimize the control of leavening. The invention contemplates that the materials, composition, relative amounts, and physical forms, i.e., shapes, sizes, properties such as solubility, and amounts of active ingredients and barrier material, and how they interact with other ingredients of the dough composition, can be chosen so that the timing of reaction between active ingredients, and therefore the timing of the expansion of the dough, is controlled to occur substantially during baking, after the dough ingredients are heated above storage temperature, above room temperature, and to a “baking temperature.” As used herein, the term “baking temperature” refers not to an oven temperature setting used for baking, but to a temperature of the dough and dough ingredients which are reached by the bulk dough composition and dough ingredients during baking, for example, early baking temperatures can be from about 100° F. to 200° F. Leavening preferably is controlled to occur before gelatinization of starch in the dough composition.

The timing of the chemical leavening reaction is preferably controlled so that minimal reaction takes place during mixing, packaging, and storing. A sufficient amount of separated active ingredients remain available in the dough composition for the dough composition to leaven normally during baking, i.e., to be substantially leavened during baking by the separated chemical leavening ingredients, for example to be leavened from a raw specific volume of a refrigerated dough composition typically in the range from about 1 to about 1.5 or 1.6 cc/gram, up to or exceeding a baked specific volume of greater than or equal to 2 cubic centimeters per gram (cc/gram), or 2.3 cc/gram, or 3 cc/gram.

Dough compositions of the invention can exhibit various advantages. They can be exceptionally stable during processing and storage. Stability of a dough composition can be measured by monitoring volume of the dough composition, and expansion, and is evident as desired degrees of expansion of the dough composition during various stages of processing, packaging, storage, and baking. Stability relates to the ability to control or prevent leavening until desired, e.g., during baking, and according to the invention can be affected by chemical and mechanical properties of the of the barrier material used to separate the active ingredients, as well as properties of the active ingredients. Stability can also advantageously show up in a dough composition as added processing line time available in producing and packaging dough compositions, especially during which the dough composition does not undergo excessive leavening. “Processing line time” refers to the time after mixing or compounding within which a dough composition can be placed into a packaging container before experiencing too much volumetric expansion to prevent insertion into the packaging container. For example, a preferred dough composition of the invention may have a processing line time in the range from about 2 to about 3 hours, as compared to other dough compositions that may even include some amount of soda particles coated or encapsulated with a type of barrier material, which may have a processing line time of generally no more than one half hour.

Preferred dough compositions of the invention can be stable as packaged under refrigerated conditions for up to or exceeding 12 weeks at about 45° F.

The ability to inhibit or control leavening or expansion during processing and refrigerated storage can advantageously eliminate the need for pressurized packaging of a dough composition. This overcomes the potential objections of consumers to the popping of pressurized cardboard cans while opening. Instead of pressurized packaging, non-pressurized packaging can be used. In a related advantage, use of low pressure packaging can make it easier to package fewer portions, e.g., of biscuits, per container, which can add an element of portion control to preferred packaged dough compositions of the invention. For example, a container may include sub-divided portions of 1, 2, or 3 portions which are packaged to be substantially air tight, but still not pressurized. More than one of those sub-divided portions can be included in a larger, non-pressurized package.

The dough product is substantially leavened by the amounts of acidic and basic active ingredients in the composition that are separated by barrier material. The dough product can thereby be leavened to a degree that would be expected as “normal” for a baked dough product of a like type and composition that does have leavening controlled as described herein, e.g., with a barrier material to separate active ingredients. A baked dough product that exhibits a “normal” degree of expansion means that the baked dough product is leavened to a degree of expansion typical for such a baked dough product. As an example, the baked specific volume (BSV) of a baked dough product of the invention can be similar to the BSV of other similar baked dough products, including similar chemically leavened baked dough products, which may be pre-proofed or which may be oven-proofed. The total amount of leavening can be measured by baked specific volume (BSV). Preferred BSVs of the baked dough product of the invention can be at least about 2 or 2.3 cc/gram, e.g., in the range from about 2.3-4 cc/gram.

Dough compositions of the invention can even exhibit improved overall BSV, such that total expansion of the baked dough product and final BSV may be increased over the BSV of a like dough composition that does not include the use of a barrier material as described. Also, use of a barrier material as described herein can be an improvement in that (for the same amount of CLA used) the absence of a barrier material may cause a product to either “pre-proof” or to experience an unacceptable degree of outgassing during storage, which can in turn cause unwanted package expansion and possible packaging failure (e.g., bursting).

An aspect of the invention relates to a dough composition. The composition includes a basic active ingredient, an acidic active ingredient, and a barrier material. At below baking temperature, the barrier material separates basic active ingredient from acidic active ingredient to inhibit reaction of basic active ingredient and acidic active ingredient. The acidic active ingredient is selected to have relatively low solubility in the dough composition. The barrier material degrades at or above baking temperature to allow the separated basic active ingredient and acidic active ingredient to come into contact in the dough composition and substantially leaven the dough composition during baking.

Another aspect of the invention relates to a dough composition comprising basic active ingredient coated by a barrier material, and acidic active ingredient coated by a barrier material.

Still another aspect of the invention relates to an unproofed, refrigerator-stable dough composition. The composition includes a basic active ingredient, an acidic active ingredient, and a barrier material. At below baking temperature, the barrier material separates basic active ingredient from acidic active ingredient to inhibit reaction of basic active ingredient and acidic active ingredient. The barrier material degrades at or above baking temperature to allow the separated basic active ingredient and acidic active ingredient to come into contact in the dough composition and substantially leaven the dough composition during baking. The barrier material is a fat-type barrier material having a solid fat index of at least about 50% at 75° F., and preferably at least about 70% at 80° F.

Still another aspect of the invention relates to a method of producing a cooked dough product. The method includes combining dough ingredients into a bulk dough composition comprising a basic active ingredient and an acidic active ingredient, the basic active ingredient and the acidic active ingredient being separated by a barrier material, wherein the dough ingredients are combined at a temperature below the melting temperature of the barrier material, and wherein the acidic active ingredient is selected to have relatively low solubility in the dough composition; refrigerating the dough composition at a temperature below the melting temperature of the barrier material; and baking the dough composition at a temperature above the melting temperature of the barrier material such that the barrier material melts, exposing one or more of the basic active ingredient or the acidic active ingredient to the bulk dough composition, allowing the separated basic active ingredient and acidic active ingredient to react to substantially leaven the dough composition during baking.

Yet another aspect of the invention relates to a method of producing a cooked dough product. The method includes combining dough ingredients into a bulk dough composition comprising a basic active ingredient and an acidic active ingredient, the basic active ingredient and the acidic active ingredient being separated by a barrier material, wherein the dough ingredients are combined at a temperature below the melting temperature of the barrier material, and wherein the barrier material is a fat-type barrier material having a solid fat index of at least about 50% at 75° F.; refrigerating the dough composition at a temperature below the melting temperature of the barrier material; and baking the dough composition at a temperature above the melting temperature of the barrier material such that the barrier material melts, exposing one or more of the basic active ingredient or the acidic active ingredient to the bulk dough composition, allowing the separated basic active ingredient and acidic active ingredient to react to substantially leaven the dough composition during baking.

The term “unproofed” is used herein to refer to a dough composition that has not been processed to include any step intended to cause proofing or leavening of the dough. For example, the dough may not have been subject to a specific holding stage for causing the volume of the dough to increase by 10% or more. The raw specific volume (RSV) of an unproofed dough composition can typically be in the range from about 0.75 to about 1.6 cubic centimeters per gram (cc/g).

“Refrigeration-stable” means that a dough composition undergoes sufficiently little leavening during refrigerated storage to be a useful commercial or consumer dough product, e.g., there is not an excessive amount of carbon dioxide outgassing during storage (the RSV remains at an acceptable level, such as from 0.9 to 1.6 cc/gram), or the carbon dioxide released from the dough does not exceed 0.46 cc/gram dough over a 12 week period of storage at about 45° F.

### BRIEF DESCRIPTION OF THE DRAWINGS

FIG. 1 is a graph (risograph) illustrating gas evolution of CO₂ versus time for refrigerated dough compositions containing soda and different encapsulated soda.

FIG. 2 is a plot of “Minutes to 60% Reaction” versus Batter Temperature, for various acidic active ingredients. FIG. 2 is taken directly form R. Carl Hoseney, Principles of Cereal Science and Technology, pp. 249, 279 (1994).

FIG. 3 is a plot of volume expansion versus time for doughs made with soda and different encapsulated soda.

FIG. 4 is a plot of package volume versus time for packaged doughs made with soda and different encapsulated soda.

### DETAILED DESCRIPTION

Chemical leavening systems of the invention include two active ingredients: a basic active ingredient and an acidic active ingredient. When the active ingredients come into contact with each other, the active ingredients react to produce a leavening gas that expands (i.e., leavens) the dough composition.

According to the invention, the basic active ingredient and the acidic active ingredient are separated in the dough composition by a barrier material that inhibits or prevents reaction of the active ingredients until a desired time or condition of processing or use, preferably to effect substantial leaving during baking. For example, during preparation of the dough, packaging, and storage of the dough (normally at a refrigerated temperature), the barrier material maintains a separation between the active ingredients and prevents their reaction.

The barrier material is degradable, meaning that the barrier material can break, melt, disintegrate, break down, or otherwise be removed from separating the active ingredients, thereby allowing the active ingredients to come into contact and react. The barrier material can be broken down at a desired time or process condition to control the point at which the dough leavens. For example, the barrier material can be broken down by exposing the dough composition to a particular processing condition such as a temperature, especially a temperature that occurs during baking but that does not occur during preparation, packaging, or storage. Preferably, the barrier material can break down at a temperature that occurs early during baking so that leavening occurs before starch gelatinization or other physical changes to the dough that would limit or hinder the dough's ability to expand.

Optionally and preferably, reaction of the active ingredients can also be controlled based on the solubility of one or more of the active ingredients. Active ingredients must dissolve or be solubilized within the dough composition before they react to leaven the dough, e.g., in an aqueous phase of the dough composition. A preferred basic or acidic active ingredient can be substantially insoluble in the bulk dough composition at preparation, packaging, and storage temperatures, and can dissolve at a baking temperature. Insolubility of an active ingredient can further prevent reaction of active ingredients and leavening of a dough composition until a desired baking condition is met. Because solubility can be selected to occur at a baking temperature, an insoluble active ingredient does not need to be separated from the bulk dough composition, e.g., does not need to be included in a dough composition as an encapsulated particle in combination with a barrier material, although such encapsulated particles are within the contemplation of the invention. According to certain embodiments of the invention, an active acid ingredient can be chosen to be relatively insoluble or less soluble than other active acid ingredients at refrigeration temperatures, but fairly soluble and baking temperatures.

Other active ingredients, typically basic active ingredients, are relatively more soluble at preparation, packaging, or storage temperatures. Such relatively soluble active ingredients can preferably be included in a dough composition of the invention in the form of an encapsulated particle that includes one or more particulates of the relatively soluble active ingredient coated with a barrier material.

Ideally, active ingredients can be completely separated by barrier material such that the active ingredients are entirely prevented from reacting prior to baking. While this is the ideal, some amount of imperfect separation or some amount of breakdown of barrier material can cause some early reaction of the active ingredients, e.g., before baking. The amount of early reaction can be kept to a suitable level.

The degree of reaction of the active ingredients prior to baking can be measured by different methods, including as the amount of gas produced by reaction of active ingredients prior to baking, or as the amount of expansion experienced by the dough prior to baking. Preferably, the dough can be designed to experience an insignificant amount of reaction between the active ingredients, and therefore insignificant or minimal expansion, prior to baking, such as less than 0.46 cc of carbon dioxide evolved per gram of dough over a 12 week period of time when stored at about 45 degrees Fahrenheit. A preferred amount of expansion can alternatively mean that the dough composition experiences less than 35 percent, e.g., less than 20 percent, and most preferably less than 10 percent expansion between the time of completing preparation of the dough composition, through packaging and storage, until a time prior to baking. Preferred dough compositions during storage and up to baking can have a raw specific volume of less than 1.6 cc/gram, preferably in the range of from about 0.9 to about 1.3 cc/gram.

Controlling, e.g., minimizing, reaction of the active ingredients during processing and storage can result in substantial portions of the active ingredients remaining unreacted and available for reaction during baking. For example, a dough product of the invention stored with refrigeration until just prior to baking, can be substantially unleavened, e.g., unproofed, and can still include sufficient amounts of unreacted active ingredients so that substantial leavening of the dough will occur during baking. Most preferably, amounts of active ingredients are present in the dough composition after storage, and during baking, are enough that a majority of or substantially all of the total amount of leavening that the dough experiences, occurs during baking. In terms of specific volume, the baked dough composition can preferably have a BSV of at least about 2 or 2.3, e.g., 2.5 or greater, up to or exceeding 3 or even 4 cc/g. Stated differently, prior to baking, the dough composition can preferably have no more than 50% of CO₂ outgassed from the dough composition (based on the total amount of outgassed CO₂ through the life of the dough composition) with a preferred amount being less than about 35%, 25%, or 10% of CO₂ outgassed from the dough composition prior to baking. The total amount of leavening (or outgassing) refers to any leavening that occurs during all processing steps, including preparation and packaging of the dough, storage, and also baking.

The barrier material can separate the active ingredients in any useful fashion that allows separation of active ingredients prior to baking, and wherein the separation can be broken down or degraded at a desired time or condition to allow the active ingredients to react. Features of the barrier material including chemical composition and physical form, including chemical and physical and mechanical properties, can be selected so that the barrier material is relatively stable during preparation, packaging, and storage conditions and temperatures, but such that the barrier material will break down or degrade upon experiencing a certain condition, such as a certain temperature that occurs during baking, causing the active ingredient to become exposed to the bulk dough composition.

According to an embodiment of the invention, controlled separation of the active ingredients can be accomplished in a bulk dough composition that includes both acidic and basic active ingredients, by placing barrier material between the bulk dough composition and either one or the other or both of the active ingredients. As mentioned above, it can be preferred to separate an active material from the bulk dough composition if the active material is soluble in the bulk dough composition at sub-baking temperatures. If an active ingredient is substantially insoluble at sub-baking temperatures, there is less of a need to separate the active ingredient from the bulk dough composition, although such separation can still be useful or desired.

Preferred modes of separation involve including in a bulk dough composition at least one active ingredient, especially a soluble active ingredient, present in the bulk dough composition, in the form of encapsulated particles containing active ingredient particulates coated or surrounded by, enrobed in, or suspended in, barrier material, e.g., active ingredient particulates substantially surrounded by a layer of barrier material.

Alternatively, compositions of the invention can include active ingredient present in the bulk dough composition and not separated from the bulk dough composition or coated by barrier material. Such an active ingredient can be included in the bulk dough composition in any form, such as in the form of a particulate that does not include a coating of barrier material, e.g., a suspended solid or a dissolved active ingredient present in the aqueous portion of the bulk dough composition. If one of a combination of active ingredients (e.g., the acidic active ingredient) is present in the bulk dough composition as a suspended, solid particulate or as an active ingredient dissolved in the aqueous phase, the other active ingredient (e.g., the basic active ingredient) is normally separated from the bulk dough composition by barrier material, such as by including the other active ingredient in the bulk dough composition in the form of encapsulated particles that include particulates of that active ingredient coated with, enrobed with, or suspended in barrier material.

In an embodiment of the invention, a refrigerated bulk dough composition can contain a combination of solid particles of substantially insoluble acidic active ingredient suspended in the aqueous phase of a bulk dough composition, with a basic active ingredient being included in the form particulates coated with and separated from the bulk dough composition by barrier material. In another embodiment, both the basic active ingredient and the acidic active ingredient are separated from the bulk dough composition by barrier material.

According to the invention, a basic active ingredient can be selected to cooperate with other ingredients of the dough composition, including the acidic active ingredient, the barrier material, and the other ingredients of the bulk dough composition, to give control of the timing of reaction between the active ingredients as described herein. The composition, size, and physical form of the basic active ingredient can be selected to cause the basic active ingredient to be stable at processing and storage temperatures, to become fully incorporated in the bulk dough composition, e.g., hydrated, during baking, and to give substantially uniform distribution during baking for reaction with the acidic active ingredient. Factors that encourage desired behavior can include one or more of the amount, particulate size (if in the form of a particulate), and solubility of the basic active ingredient or a basic active ingredient particulate.

The basic active ingredient can be any material that is reactive with the acidic active ingredient to produce a leavening gas, usually carbon dioxide. Useful basic active ingredients are generally known in the dough and bread-making arts, with examples of useful basic active ingredients including reactive basic materials such as soda, sodium bicarbonate, (NaHCO₃), potassium bicarbonate (KHCO₃), ammonium bicarbonate (NH₄HCO₃), etc. These and similar types of basic active ingredient are generally soluble in an aqueous phase of a dough composition at processing or refrigerated storage temperature.

Acidic active ingredient can be selected to cooperate with the other ingredients of the dough composition, including the basic active ingredient, barrier material, and the other ingredients of the bulk dough composition, to control the timing of reaction between the active ingredients as described herein. The composition, solubility, amount, size (if a particulate), and physical form of the acidic active ingredient can be selected to cause the acidic active ingredient to be stable (e.g., insoluble) at processing temperatures (e.g. from about 40 to about 60 degrees Fahrenheit), to be stable at refrigerated storage temperatures, and to become fully incorporated in the bulk dough composition, e.g., dissolved in the bulk dough, and preferably to achieve acceptably uniform distribution during baking for reaction with the basic active ingredient. Factors that encourage desired behavior can include one or more of the amount, particulate size (if in the form of a particulate), and solubility.

Useful acidic active ingredients are generally known in the dough and bread-making arts, with some examples including leavening phosphates such as SALP (sodium aluminum phosphate), SAPP (sodium acid pyrophosphate), and monosodium phosphate; monocalcium phosphate monohydrate (MCP), anhydrous monocalcium phosphate (AMCP), dicalcium phosphate dihydrate (DCPD). Commercially available acidic active ingredients for use according to the invention can include those sold under the trade names: Levn-Lite® (SALP), Pan-O-Lite® (SALP+MCP), STABIL-9® (SALP+AMCP), PY-RAN® (AMCP), and HT® MCP (MCP). Of these, some have low solubilities at processing and refrigerated storage temperatures, and some have relatively higher solubilities.

Preferred acidic active ingredients can have a low solubility in the bulk dough composition (e.g., the aqueous phase) at processing and refrigeration conditions, e.g., can be substantially insoluble at below baking temperatures. Low solubility during processing and storage will hinder reaction of the acidic active ingredient at those conditions. Low solubility also prevents the acidic active ingredient from dissolving and causing a reduction in pH of the bulk dough composition. It can be preferred to prevent the acidic active ingredient from solubilizing and reducing the pH of the dough composition, because a low pH can lead to negative effects such as acid hydrolysis of the protein, which can adversely affect flavor. A low pH may also prevent desired browning of the dough during baking. Thus, it can be preferred to use an acidic active ingredient with relatively low solubility at below baking temperatures, and can even be preferred to separate the acidifying agent from the bulk dough composition using a barrier material, as described herein.

In addition to low solubility of an acidic active ingredient at below baking temperatures, high solubility at baking conditions can be preferred to facilitate dissolution of the acidic active ingredient during baking, which facilitates uniform distribution of the acidic active ingredient in the bulk dough composition and reaction with the basic active ingredient. Some especially preferred acidic active ingredients can exhibit a low solubility at processing or refrigerated storage temperatures (e.g. from about 40 to about 55 degrees Fahrenheit) and can therefore remain substantially in solid suspension until baking, where at a higher temperature (e.g., a baking temperature in the range form 100° F. to 200° F.) the acidic active ingredient becomes substantially soluble, (e.g., becomes at least 90% dissolved).

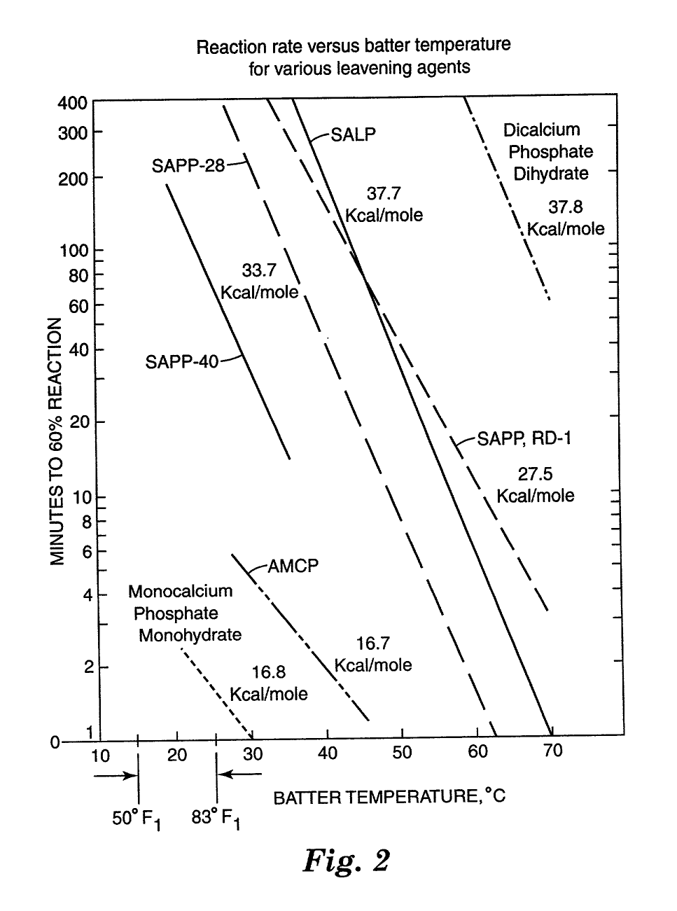

According to one aspect of the invention, the importance of solubility properties of the acidic active ingredient, especially if not separated from the bulk dough composition, is that dissolution of acidic active ingredient facilitates reaction between the basic and acidic active ingredients. The invention seeks to control that reaction, and contemplates that such control can be achieved, at least in part, by selecting the solubility of the acidic active ingredient at different temperature ranges (another way to achieve such control, with soluble or insoluble acidic active ingredients, is to separate the acidic active ingredient from the bulk dough composition, as described herein). Toward that result, preferred acidic active ingredients include those that exhibit solubility behaviors similar to SALP and SAPP (most preferably SALP). Specifically, as shown in FIG. 2, SALP and SAPP exhibit reaction rates that are relatively slow at comparatively low temperature ranges, such as below about 35-40° C. This indicates low solubility at that temperature range. The same acidic active ingredients, however, have relatively faster reaction rates, showing adequate solubility, at higher (e.g., baking) temperatures. The solubilities of acidic active ingredients shown in FIG. 2 are: SALP (37.7 kcal/mole); dicalcium phosphate dihydrate (37.8 kcal/mole) and SAPP (27.5, 33.7 kcal/mole). While many acidifying agents are certainly useful in the invention, including SAPP, those having a solubility of less than about 35 kcal/mole are not considered to have a preferred or “relatively low” solubility.

A different way to characterize preferred acidic active ingredients is to consider the “Relative Reaction Rate.” See R. Carl Hoseney, Principles of Cereal Science and Technology, 2^{nd} ed. pp. 276-81 (1994). Table 1 at page 280 of Hoseney specifies the “Relative Reaction Rates” of various leavening agents. Preferred acidic active ingredients according to the invention (especially in embodiments where the acidifying agent is not separated from the bulk dough composition) can have a Relative Reaction Rate, as measured by Hoseney, of at least 4, which specifically includes sodium aluminum phosphate, sodium aluminum sulfate, and dicalcium phosphate dihydrate.

As will be appreciated by the skilled artisan, the individual active ingredients can be included in the dough composition in respective amounts that are useful to leaven the dough composition. The amount of a chosen basic active ingredient to be used in a dough composition can be sufficient to react with the included acidic active ingredient to release a desired amount of gas for leavening, thereby causing a desired amount of expansion of the dough product. Because the basic active ingredient and the acidic active ingredient work in cooperation, each active ingredient should be included in an amount designed to work with the included amount of the other active ingredient.

Typical amounts of basic active ingredient (not including the weight of the barrier material encapsulant) can be in the range from about 0.25 to about 2 parts by weight, with ranges from about 0.75 to about 1.5 parts by weight sometimes being preferred.

The acidic active ingredient can be added in an amount sufficient to neutralize the basic component, i.e. an amount that is stoichiometric to the amount of basic active ingredient, with the exact amount by weight being dependent on the particular acidic active ingredient that is chosen. Typical amounts of acidic active ingredient such as SALP can be in the range from about 0.25 to about 2 parts by weight, with ranges from about 0.25 to about 1.5 parts by weight sometimes being preferred. In some instances, slightly less than a stoichiometric amount of acid can be used, because less than all of a basic ingredient may be released during baking, in which case the amount of acid used can match the estimated or expected amount of base released.

The barrier material used in the invention can be any material that can separate active ingredients of a chemical leavening system in a bulk dough composition, and that can be degraded, preferably at a baking temperature, to eliminate the separation and allow the ingredients to contact each other and react within the bulk dough composition. The process of breaking down the barrier material can preferably be controlled in a predictable, controllable manner, such as by raising the temperature of the dough above the melting temperature of the barrier material, to cause the barrier material to melt and allow active ingredient to be exposed to bulk dough composition.

Preferred barrier materials can be processed with particulates of active ingredient to produce encapsulated particles containing active ingredient that is at least partially protected by, coated by, enrobed in, or suspended in barrier material. The encapsulated particles including active ingredient particulates and barrier material can be included in a bulk dough composition so that the active ingredient is (at least partially) separated from the bulk dough composition, and does not substantially contact the bulk dough composition, especially the water component of the bulk dough composition. For example, a preferred barrier material can be suitable for processing the barrier material in combination with particulates of either basic active ingredient or acidic active ingredient, to produce either enrobed particulates or agglomerate particulates, each of which are described in more detail below.

Preferred barrier material can also be chosen to encourage release of enrobed or coated particulates of active ingredient into a bulk dough composition, upon degradation of the barrier material. For example, it can be preferred, of barrier materials coated on particulates of active ingredient, that the barrier material melts at a baking temperature into a liquid form that can be separated from active ingredient particulates to facilitate introduction of the particulates into the bulk dough composition. This means that when the barrier material melts, the barrier material and the particulates have a tendency to separate instead of a tendency to remain in the form of a melted barrier material coating surrounding a particulate or particulates of active ingredient in a bulk dough composition. Separation of the active ingredient particulates from the barrier material is important to disperse the active ingredient throughout the bulk dough composition. The extent to which a melted barrier material is predisposed toward separating from particulates of active ingredient can depend on factors such as the surface tension of the melted barrier material, the ratio (mass or volume) of active material to melted barrier material, the solid fat index of a fat-type barrier material, and the melting point of the barrier material, all of which can be chosen to facilitate separation.

A preferred melting point for the barrier material can be a melting point that causes a barrier material to take the form of a stable, hydrophobic solid at dough preparation, packaging, and storage temperatures, and that causes the barrier material to break down (e.g., melt) during baking. If oven temperature during baking is generally about 300 to 500° F., preferred melting points of barrier materials are generally lower, e.g., greater than 100° F., so that a melting point is something higher than refrigerated storage or room temperature, and is a temperature that the dough composition experiences during baking, but is not necessarily the temperature of the set point of the oven during baking. Particularly preferred melting points can be within the temperature range experienced by the dough composition during early stages of baking, such as from about 100° F. to about 200° F. While other temperatures can also be found to be useful, melting temperature can preferably be chosen to be below the starch gelatinization temperature typically from about 100 to about 150° F., with exemplary melting temperatures of a barrier material being in the range from about at least 100° F. up to about 140° F., preferably at least about 110° F. up to about 130° F. Thus, the barrier material can be sufficiently stable, for example, at processing and refrigerated storage temperatures to provide unreacted, separated, active ingredients to be available during baking. Furthermore, a barrier material can preferably be capable of remaining substantially physically intact upon processing, meaning that it does not substantially break down physically during preparation of the dough composition.

A useful surface tension of the barrier material can be a surface tension of a degraded (e.g., melted barrier material) that will facilitate exposure of active ingredient particulates to the bulk dough composition. As an example, a desirable surface tension is one that will facilitate separation of barrier material from the particulates upon melting of the barrier material.

Specific examples of barrier materials can include materials that are hydrophobic and that exhibit desired properties such as a desired mechanical properties, surface tension, solid fat index, and/or a desired melting point. With respect to mechanical properties, preferred barrier materials can be sufficiently strong, durable, and flexible to withstand processing of the dough composition without being fractured, e.g., broken or otherwise affected to expose active ingredient particulates, e.g., the barrier material is preferably not overly brittle. At the same time, a barrier material may be miscible with the bulk dough composition upon melting, although does not need to be.

Exemplary types of barrier materials include hydrophobic materials such as fats and emulsifiers. Specific examples include oils such as vegetable oils, including soybean oil, cotton oil, palm kernel oil, canola oil, or any other oils, especially high lauric acid triglyceride-containing oils, any of which may be used alone or in mixtures with each other or with other barrier materials. Synthetic analogs of any of these may also be useful. Synthetic analogs include synthetic materials with fatty acid compositions like the vegetable oils above, or other useful oils, including, preferably, a positional geometry of fatty acids esterified on a triglyceride.

Preferred fat-type barrier material can be those that exhibit a high solid fat index (“SFI”), which is the ratio of solid fat to liquid fat in a barrier material at a certain temperature. A barrier material having a high solid fat index will generally better protect a coated particle because the barrier is solid at a higher temperature, and is more stable during mixing and processing due to greater strength and integrity. Of course the melt point is still preferably as described elsewhere in this description. Exemplary high solid fat index values can be at least about 50% at 75° F., preferably at least about 70% at 80° F. Fat-type barrier materials having such an SFI are commercially available, as will be understood by the skilled artisan. Examples include high lauric acid fats such as LauriCal (canola) from Cargill, Neutresca (fractionated palm kernel) from Aarhus, and Cebes (fractionated palm kernel) from Aarhus.

In one embodiment of the dough compositions, the basic active ingredient can take the form of soluble particulates coated by barrier material. The acidic active ingredient can be in the form of substantially insoluble particles suspended in the bulk dough composition.

While wishing not to be bound by theory, the process involved in baking one embodiment of a dough composition of the invention can be theorized to exist and operate as follows.

Encapsulated particles comprising basic active ingredient and barrier material are configured to separate basic active ingredient from the bulk dough composition at temperatures below baking temperatures. During processing and refrigerated storage, the acidic active ingredient is suspended as a solid in and distributed throughout the water contained in the bulk dough composition. While the barrier material is maintained at a temperature below its melting temperature, the active ingredients do not come into substantial contact and do not react or cause any leavening of the dough composition. Thus, during mixing, compounding, packaging, and storage of the dough composition, the temperature of the composition can be kept below the melting temperature of the barrier material, thereby limiting or controlling the extent to which the active ingredients will react.

When it is desired to cause the active ingredients to fully react and leaven the dough composition, during baking, the baking temperature, i.e., the temperature that occurs in the dough composition during baking, will be above the melting temperature of the barrier material, and will cause the barrier material to melt. The amount of barrier material relative to the amount and size of the core particulate or core particulates are preferably selected to cause separation of the basic active ingredient particulates from the melted barrier material upon melting of the barrier material. After separation, the solubility of the basic active ingredient allows rapid hydration of the basic active ingredient into solution with the water of the bulk dough composition. Once dissolved, the basic active ingredient contacts the acidic active ingredient that has been suspended and has dissolved in the aqueous phase of the bulk dough composition upon reaching a certain temperature reached by the bulk dough composition during baking. The active ingredients react during baking to leaven the dough composition.

With respect to the total encapsulated particle size of the enrobed particles, it has been observed that enrobed particles that include particulates of basic active ingredient, of a certain size, can sometimes cause localized effects throughout a baked dough composition. Too large of encapsulated particles can result in a failure to distribute the enrobed active ingredient evenly throughout the dough composition during baking, causing localized effects such as variations in pH and spotting (with enrobed basic active ingredient particulates). Spotting means that a cooked dough product displays one or more of a dark brown spotting of the outer crust surface upon baking, or that interior crumb displays yellow spotting.

Preferably, the size of the enrobed particulate can be sufficiently small, and the enrobed active ingredient can be sufficiently soluble during baking, to allow adequately uniform distribution of the active ingredient throughout the dough composition during baking and to thereby avoid localized areas of high pH, to allow uniform and consistent baking and color development throughout the dough.

When the barrier material is a layer of a fat-type barrier material, it has been observed that a relatively thinner layer of barrier material can improve release of the core particulate into the bulk dough composition. Relatively thinner coatings of barrier material are thought to facilitate introduction of the core particulate into the bulk dough composition, by tending to allow separation of the core encapsulated particle from the degraded barrier material, based on surface energy affects. This is in contrast to thicker barrier materials, which may form a relatively immobile melted mass of barrier material within the bulk dough composition, surrounding the particulate and maintaining separation of the core from the bulk dough composition.

Separation of a core particulate from the degraded barrier material can be further encouraged by selecting the barrier material to have a surface tension in its melted form that will facilitate separation of the degraded barrier material from the core particulate. While wishing not to be bound by theory, the following factors are believed to encourage separation of active ingredient particulates from an encapsulate particle. A ratio of the mass of barrier material to the mass of active ingredient particulate is preferably sufficiently low (e.g., ≦0.5), and the active ingredient particulates can be sufficiently large enough (45-75 microns), to enable the melted barrier material to form spherical droplets upon melting, and the active ingredient particulates to migrate and protrude at the melted barrier material/water interface such that the protruding crystals exceed the surface tension of the melted barrier material and are ejected into the aqueous continuous phase of the dough composition. Combinations of these properties and behaviors facilitate release and hydration of the active ingredient particulates, preferably within a time period during the baking cycle such that effective leavening will occur while the dough is able to expand (e.g., prior to starch gelatinization).

There are at least two distinct types of encapsulated particles that include barrier material and an active ingredient. One is an “enrobed particle,” which typically includes from one to several (generally about 1 to 3) particulates of an active ingredient (the particulate is also sometimes referred to herein as the “core” or the “active core”) surrounded by or “enrobed” in a layer of barrier material. The size of the active ingredient particulate inside of the enrobed particle may typically be in the range from about 100 to about 400 micrometers, with the range from about 200 to about 375 micrometers being preferred. (The term “particulate” will be used to refer to particulates of active ingredient, e.g., the “core” particulate or particulates of enrobed particles or agglomerate particles, covered by a barrier material to form an “encapsulated particle.” The term “encapsulated particle” will be used to refer to an agglomerate or an enrobed particle that contains one or more active ingredient particulate and barrier material coating.)

The overall size of the encapsulated particle, including the one to several particulates coated with barrier material, can preferably be in the range from about 50 to about 500 micron, preferably 100 to 420 micron (meaning that the particles will pass through a sieve having mesh openings of less than or equal to 420 microns, but not through a sieve with mesh openings of less than or equal to 100 microns). Encapsulated particles having a size of greater than 100 micron can be preferred to reduce or minimize diffusion of water into the encapsulate encapsulated particle; encapsulate encapsulated particles of diameter less than about 420 micron can be preferred to reduce spotting (for soda encapsulates).

A second general type of encapsulated particle is the type known as “agglomerate particles,” (or “congealed” particles), which are encapsulated particles that include a greater number of smaller particulates of active ingredient suspended in a mass of barrier material. The size and number of active ingredient particulates in an “agglomerate” type encapsulated particle can typically be from about 2 to about 100, or more. More can be included, depending on size. The size of core particulate(s) is generally in the range from about 2 to about 50 μm. The size of the encapsulated particle can be in the range from about 50 to about 500 micrometer, with the range from about 100 to about 420 micrometer being preferred.

The relative amounts of active ingredient and barrier material in a encapsulated particle can be any useful amounts. The relative amount by weight of active ingredient to total encapsulated particle weight is sometimes referred to as “activity.” Preferred activities are those that can facilitate at least partial separation of the active ingredient from barrier material, to expose the active ingredient to the bulk dough composition. Preferably, the relative amount of barrier material to active ingredient is sufficient to substantially separate the active ingredient from the bulk dough in the form of a coating of barrier material covering particulates of active ingredient. Particularly useful activity ranges may differ for enrobed versus agglomerate encapsulated particles. Activities of at least 30 percent or 40 percent may be generally useful, up to about 60, 65, or 70 percent. For enrobed particles, preferred weight ratios or activities of active ingredient to total weight of a encapsulated particle can be in the range from about 40 to about 65 percent, more preferably from about 45 to about 55 percent active ingredient per total weight encapsulated particle. For agglomerate particles, preferred weight ratios or activities of active ingredient to total weight of a encapsulated particle can be in the range from about 30 to about 50 percent, more preferably from about 35 to about 45 percent active ingredient per total weight encapsulated particle.

Encapsulated particles can be prepared by methods known in the baking and encapsulation arts.

An example of a method for producing enrobed particles is the use of a fluidized bed. According to this method, core particulates and barrier material are concurrently introduced into a fluidized bed. As the two materials are present in the fluidized bed, the barrier material becomes coated on the surface of the core particulate. The longer the particulate is present in the fluidized bed, the thicker the coating of barrier material becomes. Preferably, the process successfully places a coating of the barrier material over the entire surface of each of the core particulates. On the other hand, the process is not always perfect, and some core particulates may be imperfectly coated, meaning that they are not fully enrobed but a portion of the surface of the core particulate remains exposed. Some amount of such imperfectly coated core particulates can be acceptable, but the amount is preferably minimized. Those familiar with in the art of encapsulation will be well acquainted with fluidized bed and congealing processes.

Agglomerate particles can be formed using a congealing process. The active ingredient can be either basic active ingredient or acidic active ingredient. According to this method, a mixture of the particulates and the melted barrier material can be prepared into a sprayable liquid. The sprayable liquid can then be sprayed into a cooling environment where droplets of the sprayable liquid mixture are caused to congeal into agglomerate particles.

Some considerations with respect to agglomerate particles are that portions of the active ingredient particulates will often be present and exposed at the surface of the agglomerate particles. As a result, the active ingredient can advantageously release very well into the bulk dough composition as the barrier material breaks down. On the other hand, because active ingredient will be present at the surface, active ingredient (e.g., basic active ingredient) will be exposed to the bulk dough composition where it may dissolve at processing or refrigerated storage temperatures into the water of the bulk dough composition, and react with the other active ingredient (e.g., acidic active ingredient).

“Enrobed” encapsulate particles constructed of one to a few enrobed active ingredient particulates, can also be enrobed with a barrier material, e.g., of fat, emulsifier, or both, in a fluidized bed. The extent of encapsulation can be a function of the amount of time spent in the fluidized bed. Typical particles can include 1, 2, or 3 particulates per encapsulated particle. Here, the active ingredient particulates are substantially enrobed, and are not substantially present at the surface of the encapsulate particles.

Those of skill will also appreciate how the active ingredients can be included in the dough compositions, separated by a barrier material as described. In particular, the enrobed or agglomerate particles can be incorporated into a dough composition prepared by known methods of combining ingredients including water, flour, salt, shortening, flavorings, and other ingredients and additives that are known and readily available to the skilled artisan. The encapsulated particles described herein and other forms of the active ingredients useful according to the invention, can be combined into such dough ingredients by similar methods known to the skilled artisan, in amounts that will be readily understood.

The invention can be used to prepare any type of dough compositions, and can be particularly useful for refrigerated dough compositions useful for preparing baked dough compositions including biscuits, crescent rolls, sweet rolls, etc.

Also, while the dough compositions are described with respect to a particular leavening system, the dough compositions can include additional ingredients that cause leavening of the dough product. This means that in addition to the described active ingredients used with the barrier material, other leavening agents may also be used if desired. Still, the invention has the advantage of allowing use of only the described chemical leavening system, including active ingredients separated by a barrier material. Preferred dough compositions of the invention do not require or include any other leavening agents. This means that leavening agents of the dough composition of the invention may consist essentially of or consist of only active chemical leavening ingredients separated by barrier material, e.g., encapsulated basic particles, and particles of an acidic active ingredient that is substantially insoluble in a bulk dough composition at relatively low temperatures but that will dissolve at higher temperatures, e.g., temperatures that the bulk dough composition will experience during baking.

The dough can be packaged and sold in a form that can be refrigerator stable. An example of a packaging configuration would be a plastic tube or pouch containing a stack of individual portions of a dough composition such as biscuits. Any materials and techniques can be used for the packaging. Typical such biscuit products are often packaged and sold in pressurized containers such as cardboard cans. The inventive dough has the advantage of being capable of being packaged without taking special measures to pressurize the packaging.

Exemplary packaging that may be useful is non-pressurized pouch/cup packaging. The container can preferably be a plastic that acts as an adequate oxygen barrier, to promote storage and freshness. Additionally, it can be preferred that the package be sized to include at least a small amount of headspace, or space for the carbon dioxide to expand into. That is, because the dough product of the invention may experience a slight amount of expansion or outgassing during refrigerated storage, the packaging should accommodate such a small amount of outgassing, preferably without a substantially noticeable change in the packaging appearance. The use of headspace, or packaging the dough in a package that is slightly larger than needed, optionally with slight vacuum during the packaging process, allows such expansion or outgassing.

Also, purging the product and packaging to remove oxygen, for example using a purge of nitrogen gas, can preferably be used to control graying. Preferred amounts of oxygen in a packaged dough product can be below about 0.20 micromoles of O₂ per square centimeter of dough surface area.

### EXAMPLES

The following biscuit dough samples were prepared to compare the use of different encapsulated particles.

Batch size (gm): 2000

| Ingredients | % | gm |
|---|---|---|
| flour, hard | 38.85 | 777 |
| flour, soft | 9.02 | 180.4 |
| water | 18.52 | 370.4 |
| ice | 9.27 | 185.4 |
| shortening chips* | | |
| buttermilk | 2 | 40 |
| sucrose | 2.25 | 45 |
| dextrose | 2.25 | 45 |
| SALP | 1.67 | 33.4 |
| soda | | |
| salt | 1.3 | 26 |
| wheat protein isolate | 0.2 | 4 |
| Cyrogel SG | 0.6 | 12 |
| SUB-TOTAL | 85.93 | 1718.6 |
| Run 1 | | |
| encapsulated soda #1 | 3.036 | 60.72 |
| shortening chips | 11.034 | 220.68 |
| Run 2 | | |
| encapsulated soda #2 | 2.78 | 55.6 |
| shortening chips | 11.29 | 225.8 |
| Run 3 | | |
| sodium bicarbonate | 1.67 | 33.4 |
| shortening chips | 12.4 | 248 |

E-soda #1: 55% active, 110° F. mp e-soda made with LauriCal.
E-soda #2: 60% active e-soda, 145° F. mp made with hydrogenated cottonseed oil.

Mixing (Spiral Mixer):

1. Combine all dry ingredients except shortening chips.

2. Add combined dries to mixer and mix 30 seconds slow speed.

3. Add liquids plus ice to mixer.

4. Mix 30 seconds slow speed followed by 120 seconds on high speed.

5. Add shortening chips.

6. Mix 30 seconds slow speed followed by 120 seconds high speed.

Target dough temperature 55-60° F.

Sheeting:

7. Sheet 1000 gm dough pad to approximately 13 mm; do a three fold and turn 90°; sheet to 13 mm

8. Cut biscuits with 3″ cutter to 63+/−3 gm

Packaging:

Flushing Gas: N2

Formulas: Three separate biscuit dough samples were made for this study, one with free sodium bicarbonate and two with separate encapsulated soda (e-soda) samples.

Dough Formula and Process:

Encapsulated e-soda samples manufactured by BalChem Corporation P.O. Box 175, Slate Hill, N.Y. 10973

Encapsulate Table

| Physical Properties | E-soda #1 | E-soda #2 |
|---|---|---|
| Substrate | Sodium Bicarbonate | Sodium Bicarbonate |
| Activity | 55% | 60% |
| Coating | LauriCal (hydrogenated | Hydrogenated cottonseed |
| | canola oil) | plus emulsifiers |
| Melt Point | 110° F. | 140 +/− 5° F. |
| Granulation | 2% max on 40 mesh | 2% max on 40 mesh |

Dough Expansion Analysis:

For each dough formula variable, two 65 gm biscuits were placed into a 1000 ml graduated cylinder. 225 ml soybean oil was added to the cylinder plus biscuits. Recorded oil volume vs time at 75° F. hourly over 3 hours plus time 0.

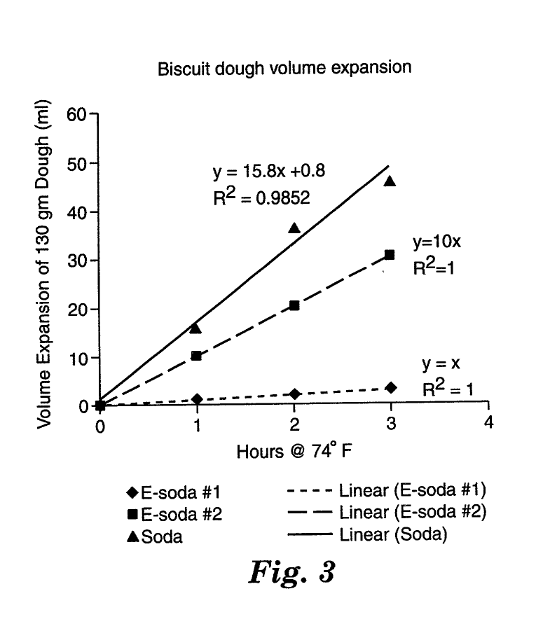

FIG. 3: Dough Volume vs Time @ 74° F.

Dough made with free soda displayed the fastest expansion rate upon incubation at 74° F. at 0.122 ml/gm/hr followed by dough made with e-soda #2 at 0.077 ml/gm/hr. Dough made with e-soda #1 displayed the slowest expansion rate at 0.008 ml/gm/hr. These results indicate that the amount of out gassing observed at room temperature in dough made with e-soda #1 is significantly less compared to dough made with e-soda #2 and dough made with free soda.

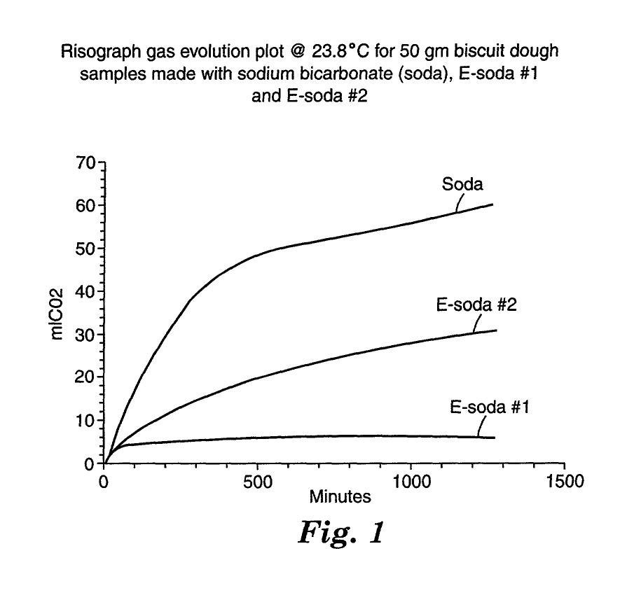

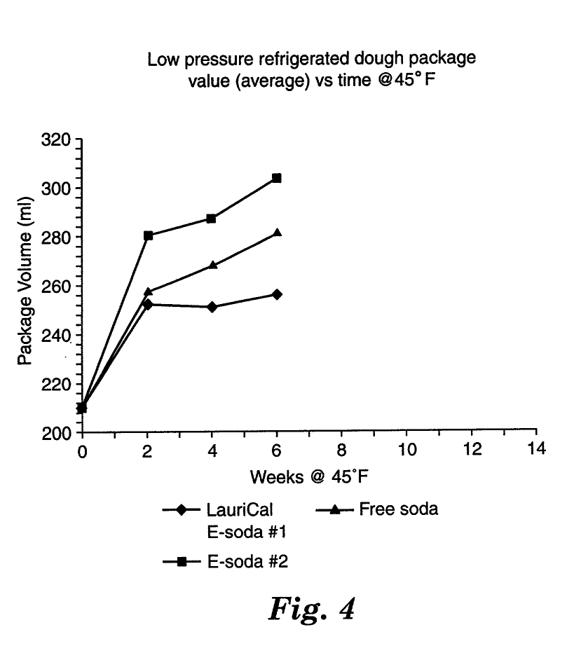

FIGS. 1 and 4 also compare the three dough compositions based on Risograph Gas Evolution versus time (FIG. 1) and Package Volume versus time (FIG. 4). For FIG. 1, dough was placed in the Risograph after mixing and before sheeting. For FIG. 4, each package contained 2 biscuits of 63±3 grams, was flushed with N₂, and was kept at 45° C.

1. A dough composition comprising a basic active ingredient, an acidic active ingredient, and a barrier material, wherein
at below baking temperature the barrier material separates basic active ingredient from acidic active ingredient to inhibit reaction of basic active ingredient and acidic active ingredient,
the acidic active ingredient is selected to have relatively low solubility in the dough composition below baking temperature and to be substantially soluble in the bulk dough composition during baking, and
the barrier material degrades at or above the baking temperature to allow the basic active ingredient and acidic active ingredient to come into contact in the dough composition and react to substantially leaven the dough composition during baking.

2. The composition of claim 1 wherein the dough composition has a raw specific volume in the range from about 1.0 to about 1.6 cubic centimeters per gram, and the dough composition can be baked to a specific volume of at least about 2.0 cubic centimeters per gram.

3. The composition of claim 1 wherein the dough composition contains from about 0.25 to about 2 wt % basic active ingredient encapsulated in barrier material, and an amount of acidic active ingredient to neutralize the encapsulated basic active ingredient.

4. The composition of claim 3 wherein the composition contains no other leavening agent except for the separated about 0.25 to about 2 wt % basic active ingredient and the amount of acidic active ingredient to neutralize the about 0.25 to about 2 wt % encapsulated basic active ingredient.

5. The composition of claim 1 wherein the acidic active ingredient comprises a suspended solid that is relatively insoluble at processing and refrigerated storage temperatures, which dissolves and solubilizes into the aqueous phase of the dough composition when the dough composition reaches a baking temperature in the range from about 100° F. to 200° F.

6. The composition of claim 1 wherein the acidic active ingredient has a solubility of greater than 35 kcal/mole.

7. The composition of claim 1 wherein the acidic active ingredient is selected from the group consisting of sodium aluminum phosphate, sodium acid pyrophosphate, and mixtures thereof.

8. The composition of claim 1 wherein the acidic active ingredient is sodium aluminum phosphate.

9. The composition of claim 1 comprising encapsulated particles comprising basic active ingredient and barrier material.

10. The composition of claim 9 wherein the basic active ingredient is soluble in a water phase of the dough composition at one or more of a processing or refrigeration storage temperature.

11. The composition of claim 9 wherein the basic active ingredient is chosen from the group consisting of sodium bicarbonate, potassium bicarbonate, ammonium bicarbonate, and combinations thereof.

12. The composition of claim 1 wherein the barrier material has a melting temperature of at least 90° F.

13. The composition of claim 12 wherein the barrier material comprises a fat-type barrier material selected from the group consisting of palm kernel oil, canola oil, a synthetic analog of palm kernel oil or canola oil, and combinations thereof.

14. The composition of claim 9 wherein the encapsulated particles comprise from about 40 to about 65 weight percent active basic material.

15. The composition of claim 9 wherein the encapsulated particles have an average size in the range from about 100 to about 420 microns.

16. The composition of claim 1 wherein the basic active ingredient is sodium bicarbonate.

17. The composition of claim 1 wherein the baking temperature is in the range from about 100® F. to about 200° F.

18. The composition of claim 1 wherein the barrier material is a fat-type barrier material having a solid fat index of at least about 50% at 75° F.

19. The composition of claim 1 comprising encapsulated particles comprising particulates of basic active ingredient dispersed in a barrier material coating, wherein the size and composition of the particulates, and the relative amount, thickness, and composition of the barrier material coating, are selected such that the basic active ingredient particulates become exposed to bulk dough composition and become hydrated during baking.

20. A dough composition comprising encapsulated particles comprising basic active ingredient particulates coated by barrier material, and further comprising encapsulated particles comprising acidic active ingredient particulates coated by barrier material.

21. The composition of claim 20 wherein the dough composition has a raw specific volume prior to cooking in the range from about 1.0 to about 1.6 cubic centimeters per gram, and the dough composition can be baked to a specific volume in the range from about 2.0 to about 3.0 cubic centimeters per gram.

22. The composition of claim 20 wherein the barrier materials are the same or different, and each independently has a melting point in the range from about 90° F. to about 160° F.

23. The composition of claim 20 wherein the barrier materials are the same or different and independently comprise a vegetable oil chosen from the group consisting of palm kernel oil, canola oil, a synthetic analog of palm kernel oil or canola oil, and combinations thereof.

24. The dough composition of claim 20 wherein
at below baking temperature the barrier materials separate each of the basic active ingredient and acidic active ingredient from bulk dough composition, and
the barrier materials degrade at or above baking temperature to allow the basic active ingredient and acidic active ingredient to come into contact in the bulk dough composition to react and leaven the dough composition during baking.

25. The dough composition of claim 20 wherein the acidic active ingredient is selected from the group consisting of sodium aluminum phosphate, sodium aluminum sulfate, sodium acid pyrophosphate, monosodium phosphate, monocalcium phosphate monohydrate, anhydrous monocalcium phosphate, dicalcium phosphate dihydrate, and mixtures thereof.

26. The dough composition of claim 20 wherein the acidic active ingredient is selected from the group consisting of sodium aluminum phosphate, sodium acid pyrophosphate, and mixtures thereof.

27. A dough composition comprising a basic active ingredient, an acidic active ingredient, and a barrier material, wherein
at below baking temperature, barrier material separates basic active ingredient from acidic active ingredient to inhibit reaction of basic active ingredient and acidic active ingredient,
the barrier material degrades at or above baking temperature to allow the basic active ingredient and acidic active ingredient to come into contact in the dough composition and substantially leaven the dough composition during baking, and
the barrier material is a fat-type barrier material having a solid fat index of at least about 50% at 75° F.

28. The composition of claim 27 wherein the barrier material comprises a vegetable oil selected from the group consisting of palm kernel oil, canola oil, and combinations thereof.

29. A method of producing a cooked dough product, the method comprising
combining dough ingredients into a bulk dough composition comprising a basic active ingredient and an acidic active ingredient, the basic active ingredient and the acidic active ingredient being separated by barrier material, wherein the dough ingredients are combined at a temperature below the melting temperature of the barrier material, and wherein the acidic active ingredient is selected to have relatively low solubility in the dough composition at below baking temperature,
refrigerating the dough composition at a temperature below the melting temperature of the barrier material, and
baking the dough composition at a temperature that causes bulk dough composition to reach a baking temperature above the melting temperature of the barrier material such that the barrier material melts, exposing one or more of the basic active ingredient or the acidic active ingredient to the bulk dough composition, allowing the basic active ingredient and acidic active ingredient to react to leaven the dough composition during baking.

30. The method of claim 29 wherein the dough composition contains from about 0.25 to about 2 weight percent basic active ingredient separated by barrier material from an amount of acidic active ingredient sufficient to neutralize the basic active ingredient.

31. The method of claim 29 wherein the barrier material has a melting point in the range from about 90° F. to about 160° F.

32. The method of claim 29 wherein the basic active ingredient is chosen from the group consisting of sodium bicarbonate, potassium bicarbonate, ammonium bicarbonate, and mixtures thereof.

33. The method of claim 32 wherein the baking temperature is greater than 100° F.

34. The method of claim 29 wherein the barrier material comprises a hydrophobic material selected from the group consisting of a fat, an emulsifier, and combinations thereof.

35. A method of producing a cooked dough product, the method comprising
combining dough ingredients into a bulk dough composition comprising a basic active ingredient and an acidic active ingredient, the basic active ingredient and the acidic active ingredient being separated by a barrier material, wherein the dough ingredients are combined at a temperature below the melting temperature of the barrier material, and wherein the barrier material is a fat-type barrier material having a solid fat index of at least about 50% at 75° F., and
refrigerating the dough composition at a temperature below the melting temperature of the barrier material, and
baking the dough composition at a temperature that raises the bulk dough composition to a baking temperature above the melting temperature of the barrier material such that the barrier material melts, exposing one or more of the basic active ingredient or acidic active ingredient to the bulk dough composition, allowing the basic active ingredient and acidic active ingredient to react to leaven the dough composition during baking.
